(19) United States
(12) Patent Application Publication
(10) Pub. No.: US 2006/0277805 A1
(43) Pub. Date: Dec. 14, 2006

(54) Gaming machine with common alterable signage display

(75) Inventors: Thomas Kopera, Villa Park, IL (US); Wayne H. Rothschild, Northbrook, IL (US)

Correspondence Address: Daniel J. Burnham;JENKENS & GILCHRIST,, A PROFESSIONAL CORPORATION, 225 W. Washington, Ste. 2600, Chicago, IL, 60606-3418, US

(73) Assignee: WMS Gaming, Inc.

(21) Appl. No.: 11/448,423

(22) Filed: Jun. 7, 2006

Related U.S. Application Data
(60) Provisional application No. 60/690,117, filed on Jun. 13, 2005.

(51) Int. Cl. G09F 7/00

(52) U.S. Cl. 40/584

(57) ABSTRACT

A gaming machine for conducting a wagering game includes a game display and a signage display. The game display is for displaying the wagering game. The signage display includes a standard support member for mounting artwork thereon. The support member may be positioned in a plurality of different orientations to alter the appearance of the signage display, thus simplifying the ability to convert the gaming machine to a new theme.

### REFERENCE TO RELATED APPLICATIONS

This application claims the benefit of priority of U.S. Provisional Patent Application No. 60/690,117, filed Jun. 13, 2005, which is hereby incorporated by reference in its entirety.

This application is related to co-pending U.S. Publication 2005/00544449, published Mar. 10, 2005, entitled “GAMING MACHINE WITH COMMON TOP BOX SUBSTRUCTURE,” which is hereby incorporated by reference in its entirety.

### Field of the Invention

The present invention relates generally to gaming machines and, more specifically, to a gaming machine with a common, alterable signage display or marquee. The marquee is rotatable to allow for variable appearances thus simplifying design for marquee components and allowing easier game theme changes.

### BACKGROUND OF THE INVENTION

Gaming machines, such as slot machines, video poker machines and the like, have been a cornerstone of the gaming industry for several years. Generally, the popularity of such machines with players is dependent on the likelihood (or perceived likelihood) of winning money at the machine and the intrinsic entertainment value of the machine relative to other available gaming options. Players also appreciate the reliability of a gaming machine, as do the casino operators. Shrewd operators consequently strive to employ the most entertaining, exciting, and reliable machines available because such machines attract frequent play and hence increase profitability to the operator.

Gaming machines display a variety of visual attraction devices, models, signs, and other forms of information. Methods used to display these items include fixed permanently printed glass, video displays, fixed artwork, model and marquee displays.

Historically, gaming machines presented a single game, top box display, and marquee. To alter game offerings, casino operators or contracted manufacturer technicians needed to replace the entire gaming machine or the entire top box display and marquee. If the game were to be relocated to a different position on the casino floor, the entire machine would have to be moved. Replacement and relocation processes are slow and counter-productive to maintaining pace with the continuously changing gambling industry. To better serve their customers, a method of converting and/or moving games quickly is needed.

Gaming machine manufacturers, especially those that produce video-based gaming machines, have responded quickly to this need. One such response is the development of a basic gaming terminal (one that is universal to all their game offerings) allowing multiple games to be presented on the same machine or allowing easy conversion to a new game. This method addresses the issue of offering more games and placing them at optimal locations during peak playing times, and also addresses the issue of changing games to the latest offerings by the gaming machine manufacturer (by performing a software conversion).

What is not addressed is the ability to transition the marquee easily when a conversion to a new game occurs. For example, if a casino operator decides that a certain video reel slot game, using a particular molded marquee, has reached the end of its useful playing life on the casino floor, the operator contacts the manufacturer and requests a conversion of the gaming machine to a newer, perhaps more popular game. While the conversion of the main video-based reel slot game is a simple software and perhaps a surface artwork change, the marquee typically requires a complete replacement. This can be time-consuming, cumbersome, expensive and also result in obsolete parts.

To help make gaming machine conversions faster, easier, and more cost effective, the use of a common, alterable marquee in accordance with the present invention would reduce the variations of assembly mechanisms in marquee offerings, simplify the conversion process, and reduce the time and effort required to alter the marquee of a gaming machine.

### SUMMARY OF THE INVENTION

The present invention provides a gaming machine for conducting a wagering game. The gaming machine includes a game display and a marquee. The game display is for displaying the wagering game. The marquee includes a standard support member for mounting artwork thereon. The support member may be positioned in a plurality of different orientations to alter the appearance of the marquee, thus simplifying the ability to convert the gaming machine to a new theme.

### BRIEF DESCRIPTION OF THE DRAWINGS

The foregoing and other advantages of the invention will become apparent upon reading the following detailed description and upon reference to the drawings in which:

FIG. 1 is a perspective view of a gaming machine with a marquee in accordance with the present invention

FIG. 2 is a block diagram of a control system suitable for operating the gaming machine;

FIG. 3 is a perspective view of the marquee for the gaming machine;

FIG. 4 is a perspective view of the marquee in an altered position and bearing different artwork;

FIG. 5 is a front view of the marquee shape in FIG. 3;

FIG. 6 is a front view of the marquee shape in a first altered position;

FIG. 7 is a front view of the marquee shape in a second altered position;

FIG. 8 is a front view of the marquee shape in a third altered position;

FIG. 9 is a perspective view of a marquee for a gaming machine in accordance with an alternative embodiment of the present invention;

FIG. 10 is a front view of the marquee shape in FIG. 9;

FIG. 11 is a front view of the marquee shape in a first altered position;

FIG. 12 is a front view of the marquee shape in a second altered position;

FIG. 13 is a front view of the marquee shape in a third altered position;

FIG. 14 is an exploded perspective view of the marquee display in FIG. 9;

FIG. 15 is a sectional view taken generally along line 15-15 in FIG. 9;

FIG. 16 is a partially exploded perspective view of the marquee in FIG. 9, showing an alternative mounting and rotation mechanism; and

FIG. 17 is a sectional view similar to FIG. 15, but showing an alternative mounting and positioning mechanism.

While the invention is susceptible to various modifications and alternative forms, specific embodiments have been shown by way of example in the drawings and will be described in detail herein. However, it should be understood that the invention is not intended to be limited to the particular forms disclosed. Rather, the invention is to cover all modifications, equivalents, and alternatives falling within the spirit and scope of the invention as defined by the appended claims.

### DESCRIPTION OF SPECIFIC EMBODIMENTS

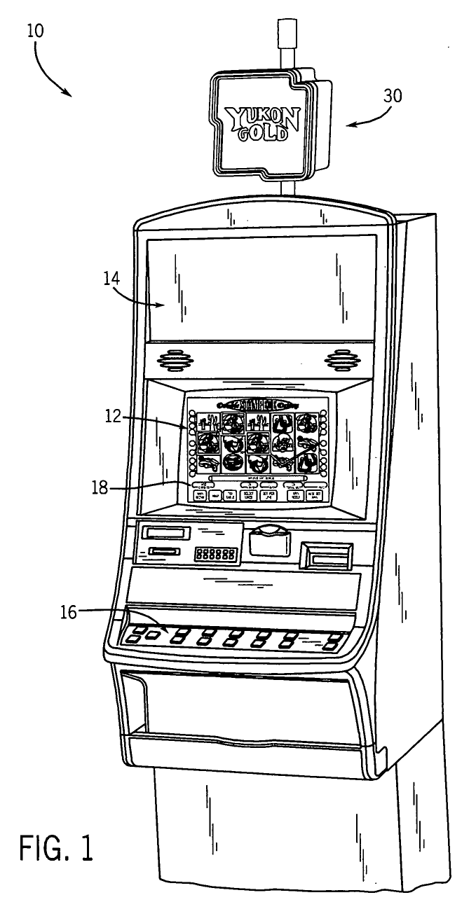

FIG. 1 depicts a gaming machine 10 operable to conduct a slot-based wagering game. In operation, the gaming machine receives a wager from a player to purchase a “play” of the game. In a “play” of the game, the gaming machine generates at least one random event and provides an award to the player for a winning outcome of the random event. The random event may be internally or remotely determined using a random number generator or pooling schema. To portray the random event and outcome to the player, the gaming machine includes a primary display 12. If the wagering game is a reel slot game, for example, the primary display 12 includes a plurality of symbol-bearing reels that are rotated and stopped to place symbols on the reels in visual association with the pay line. The game could also include games such as poker, keno, blackjack, roulette or any-other electronic wagering game.

The primary display 12 may be implemented with a CRT, LCD, plasma, mechanical reels (in the case of a reel slot game), or other type of display known in the art. The primary display 12, especially if implemented in video, may be overlaid with a touch screen to facilitate interaction with the player. In the illustrated embodiment, the gaming machine 10 is an “upright” version in which the primary display 12 is oriented vertically relative to the player. Alternatively, the gaming machine may be a “slant-top” version in which the primary display 12 is slanted at about a thirty-degree angle toward the player of the gaming machine 10.

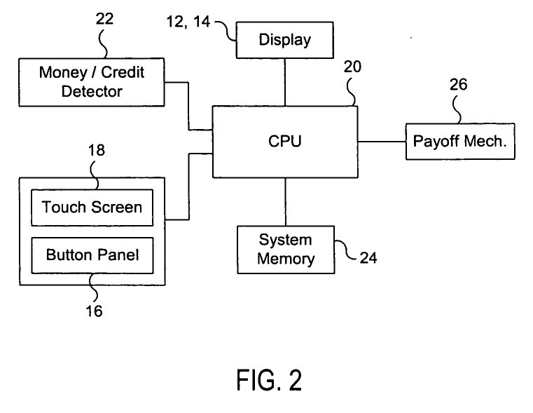

FIG. 2 is a block diagram of a control system suitable for operating the gaming machine. Money/credit detector 22 signals a central processing unit (CPU) 20 when a player has inserted money or played a number of credits. Using a button panel 16 and/or a touch screen 18 (also see FIG. 1), the player may select any variables associated with the wagering game and place his/her wager to purchase a play of the game. In a play of the game, the CPU 20 generates at least one random event using a random number generator (RNG) and provides an award to the player for a winning outcome of the random event. Alternatively, the random event may be generated by a remote computer using an RNG or pooling schema and then transmitted to the gaming machine. The CPU 20 operates the display 12 to represent the random event(s) and outcome(s) in a visual form that can be understood by the player. In addition to the CPU 20, the control system may include one or more additional slave control units for operating the display 12 and any secondary displays.

System memory 24 stores control software, operational instructions and data associated with the gaming machine. In one embodiment, the system memory 24 comprises a separate read-only memory (ROM) and battery-backed random-access memory (RAM). However, it will be appreciated that the system memory 24 may be implemented on any of several alternative types of memory structures or may be implemented on a single memory structure. In fact, the system memory 24 may be located locally or remotely over a network. A payoff mechanism 26 is operable in response to instructions from the CPU 20 to award a payoff to the player. The payoff may, for example, be in the form of a number of credits. The number of credits is determined by one or more math tables stored in the system memory 24.

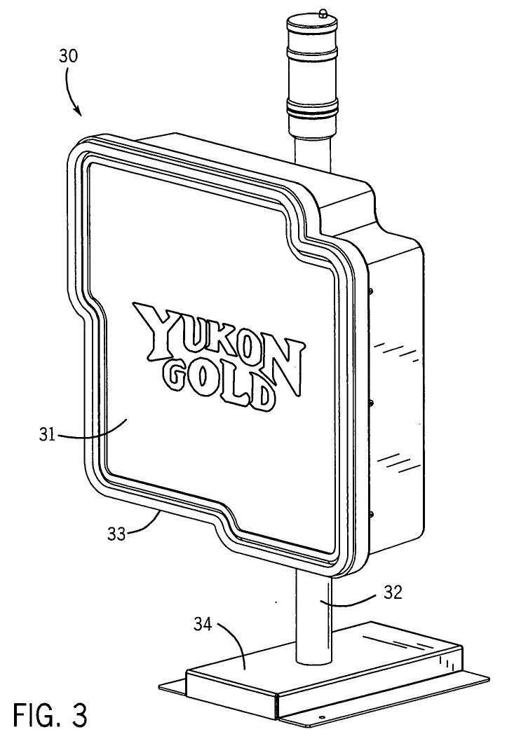

FIG. 3 shows an example of a signage display in the form of a marquee 30 for a gaming machine. In this embodiment, the marquee 30 is comprised of artwork 31 area and a frame or support member 33. The artwork 31 can be backlit, front-lit or edge-lit by any lighting method including incandescent, fluorescent, LEDs, neon, and cold cathode fluorescent lamp (CCFL). The artwork may in fact not be illuminated. The artwork 31 in this embodiment is for a video reel slot game YUKON GOLD. The marquee 30 is mounted to a post 32. The post 32 is mounted to a base plate 34. The base plate 34 is affixed to the top of the gaming machine 10 (see FIG. 1). The method by which the marquee 30 is connected to the post 32 can be any technique that allows the marquee 30 to be rotated manually during a conversion of the gaming machine. Typically, a number of positions can be presented based on the design of the marquee 30. Because each of the four sides of this marquee 30 is different, it can be presented in eight different positions. To alter the look even further, a change to the support member's 33 bezel or edge can also give the impression that an entirely new marquee has been used when a gaming machine is converted. The change can be color, material, and secondary lighting. In many cases, when the marquee 30 is rotated, new artwork 31 is used to facilitate logical viewing regarding the new marquee 30 position and identify the new game. In some cases, the marquees 30 of adjacent machines may use common artwork, but be angled differently to make a group of machines appear to be less uniform.

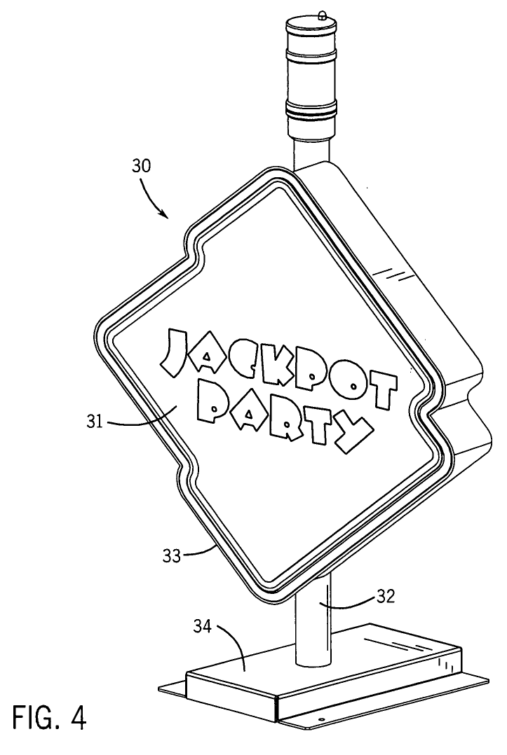

FIG. 4 shows the same marquee 30 shown in FIG. 3 rotated 45 degrees clockwise to present a different view. This embodiment shows a different title in the artwork display 31, JACKPOT PARTY. The orientation of the JACKPOT PARTY artwork accommodates the orientation of the marquee 30, both relative to the orientation necessary for logical viewing. In the case of text artwork, logical viewing means that the text is oriented in a generally upright manner for easy comprehension.

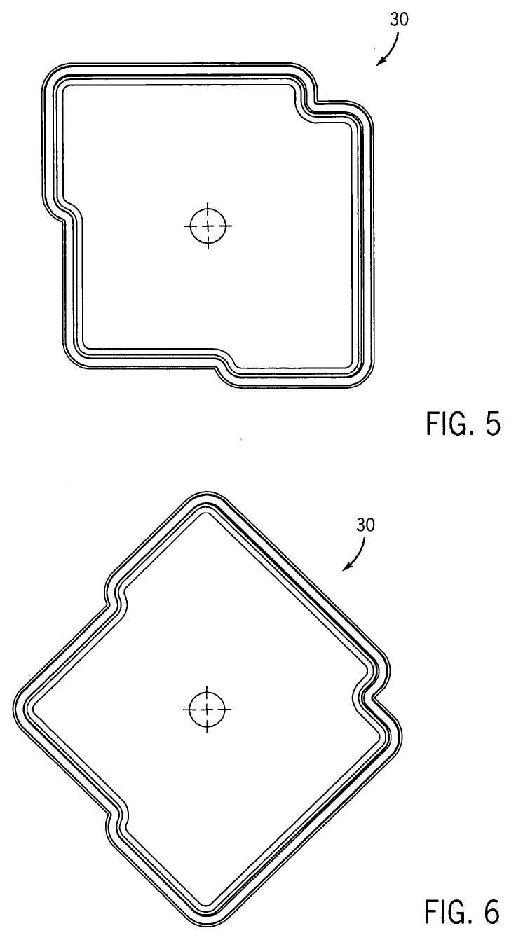

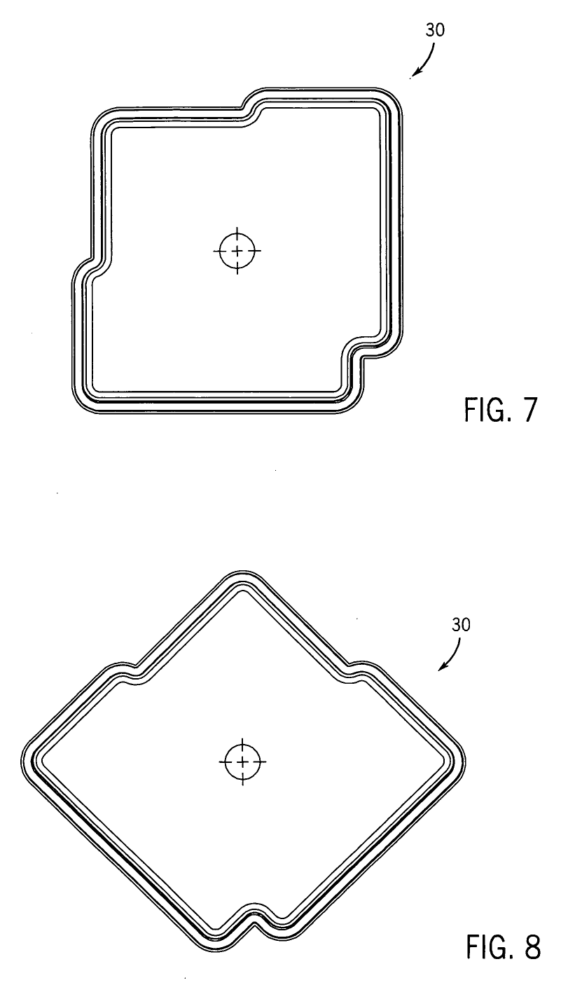

FIG. 5 shows a front view of the marquee 30 of FIGS. 3 and 4. In this embodiment, the shape of the marquee 30 is generally square but having variations on all four sides providing a different view depending on its position. FIG. 6 shows the marquee 30 of FIG. 5 rotated 45 degrees clockwise. The orientation of the marquee 30 varies considerably from the position shown in FIG. 5. FIG. 7 shows the marquee 30 of FIG. 5 rotated 90 degrees clockwise. Once again, the orientation varies from the initial position. FIG. 8 shows the marquee 30 of FIG. 5 rotated 135 degrees clockwise. Because all four sides of the marquee 30 vary, multiple presentations are possible. If the marquee 30 is rotated 45 degrees each time, a total of eight different positions are possible. As will be appreciated by those with ordinary skill in the art, the number of unique sides of a shape determines the number of different views attainable. For example, the positions may be at 15 degree increments yielding 24 possible positions.

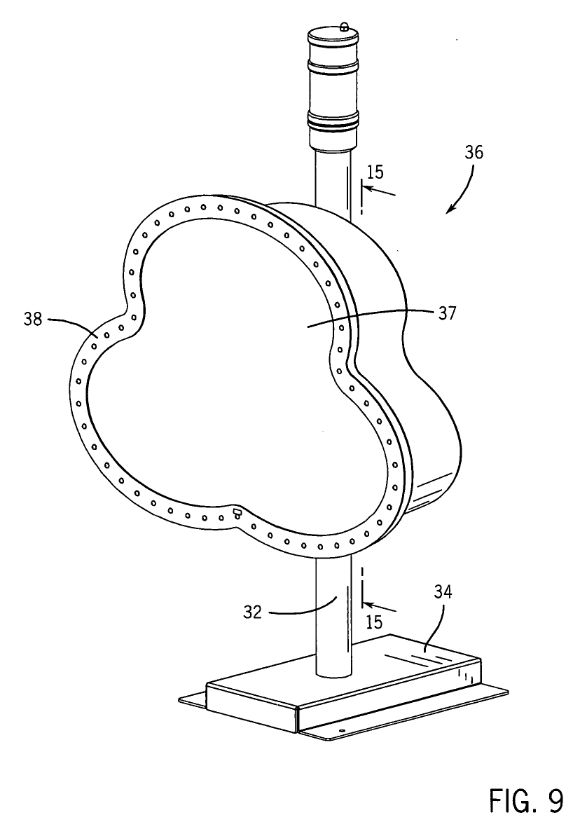

FIG. 9 shows a different shape used for the marquee of a gaming machine. Compared to the marquee 30 in FIGS. 3 and 4, this marquee 36 varies in visual appearance because of its rounded “cloud” shape and a different bezel 38.

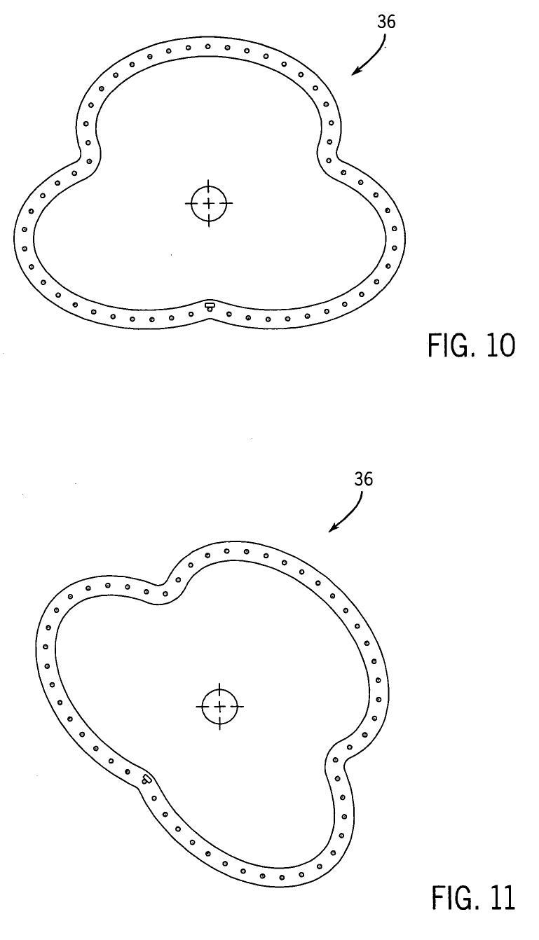

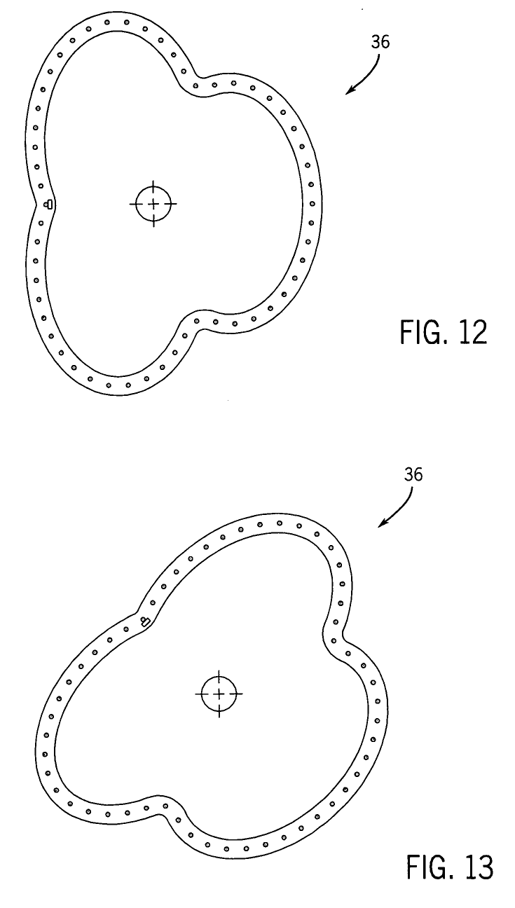

FIG. 10 shows a front view of the marquee 36 of FIG. 9. In this embodiment, the marquee 36 is generally a rounded “cloud” shape having variations on all sides that provide a different view depending on how it is positioned. FIG. 11 shows the marquee 36 of FIG. 10 rotated 45 degrees clockwise. The orientation of the marquee 36 varies considerably from the position shown in FIG. 10. FIG. 12 shows the marquee 36 of FIG. 10 rotated 90 degrees clockwise. Once again, the orientation varies from the initial position. FIG. 13 shows the marquee 36 of FIG. 10 rotated 135 degrees clockwise. Because all sides of the marquee 36 vary, multiple presentations are possible. If the marquee 36 is rotated 45 degrees each time, a total of eight different positions are possible. As will be appreciated by those with ordinary skill in the art, a marquee, rotatable on a central pivot point, can be turned in one of two directions. The pivot point may also be located off center providing further differentiation to the appearance of the marquee 36.

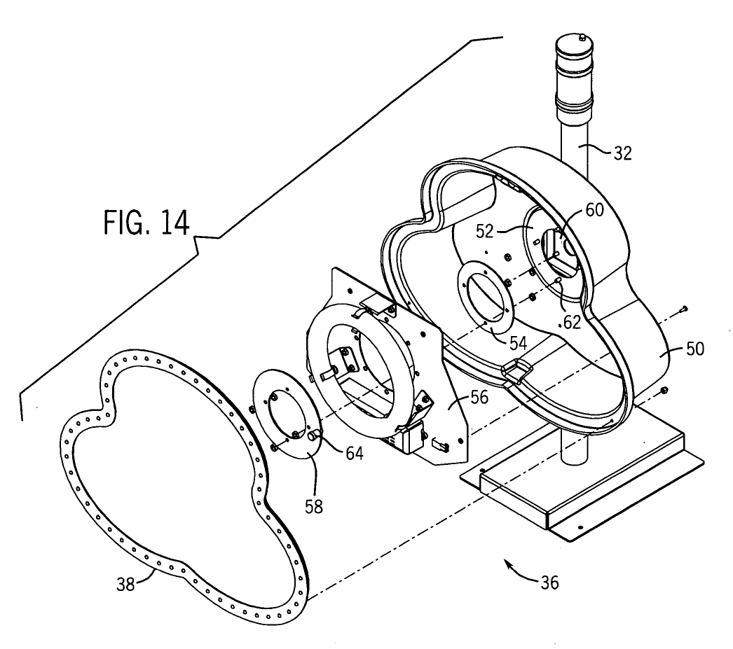

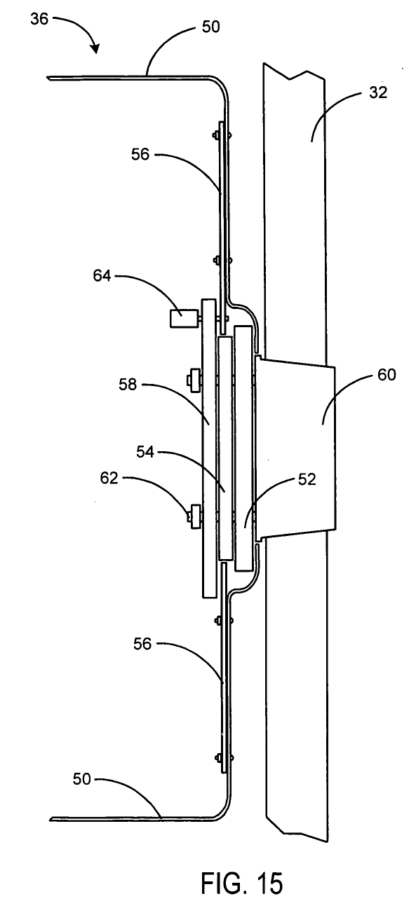

FIG. 14 is an exploded perspective view of a cloud shaped marquee showing a mounting arrangement and pivot mechanisms that allow the marquee 36 to be securely attached to post 32 and rotated manually when needed. Support member of marquee box 50 is placed around post mounting bracket 60. Note that the location of the mounting bracket 60 can be adjusted relative to the post 32. An initial washer 52 is then placed on the post mounting bracket 60 by way of four mounting studs 62. The initial washer 52 is seated within a recess in the marquee box 50 (see FIG. 15) and, once fastened, prevents the marquee box 50 from moving forward from its intended position. A spacing washer 54 is attached also using the mounting studs 62. A light mounting plate 56 is attached to the back of the marquee box 50. A position control washer 58 with a locking pin 64 is mounted onto mounting studs 62. Initial washer 52, spacing washer 54 and position control washer 58 are all secured using threaded nuts attached to the four mounting studs 62. The bezel 38 is attached using screws or is snapped into place to finish the marquee assembly.

FIG. 15 is a sectional view of an assembled marquee 36. Marquee box 50 is placed around post mounting bracket 60. An initial washer 52 is placed on the post mounting bracket 60 by way of four mounting studs 62. The initial washer 52 is seated within a recess in the marquee box 50. A spacing washer 54 is attached also using the mounting studs 62. A light mounting plate 56 is attached to the back of the marquee box 50. A position control washer 58 with a locking pin 64 is mounted onto mounting studs 62. Initial washer 52, spacing washer 54 and position control washer 58 are all secured using threaded nuts attached to the four mounting studs 62. The recess in the marquee box 50 and the light mounting plate 56 provide the spacing necessary to allow the marquee 36 to be rotated around the washer assembly comprised of initial washer 52, spacing washer 54, and position control washer 58. The initial washer 52, in its fixed position, is “sandwiched” between the marquee box 50 and the light mounting plate 56. Eight position holes on the light mounting plate 56 allow the locking pin 64 on the position control washer 58 to lock the marquee 36 in one of eight different orientations. Washers 52, 54, and 58 remain stationary when the marquee box 50 with the attached light mounting plate 56 is being rotated.

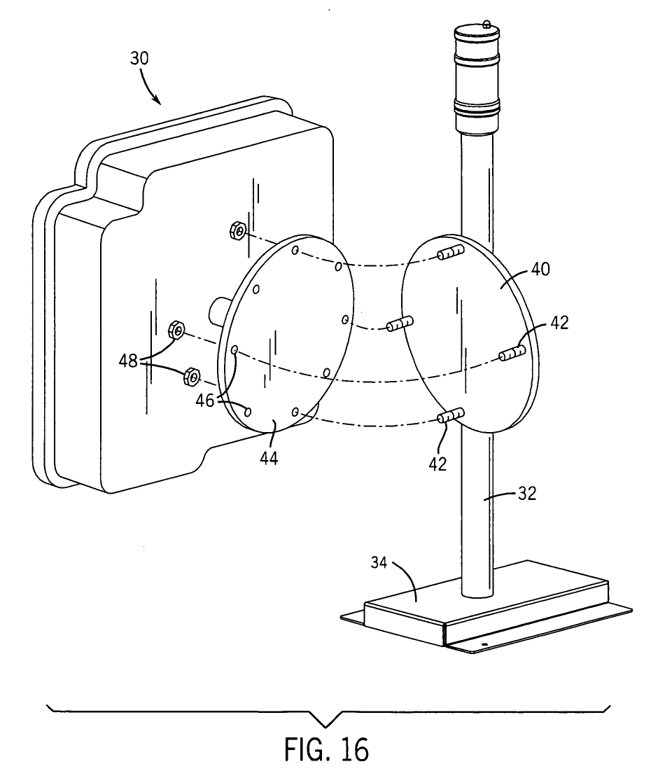

FIG. 16 shows an alternative mounting bracket used to attach the marquee 30 to the post 32. Attached to the post 32 is a mounting bracket 40. Threaded studs 42 protrude from the mounting bracket 40 and are positioned at zero, 90, 180, and 270 degrees. A mounting plate 44 is attached to the back of the marquee 30. Holes 46 are positioned every 45 degrees starting at zero (top) near the edge of the mounting plate 44. This allows the marquee 30 to be rotated in increments of 45 degrees to realize one of the eight positions possible for this shape. Nuts 48 are used to secure the marquee 30 to the mounting bracket 40.

While the present invention has been described with reference to one or more particular embodiments, those skilled in the art will recognize that many changes may be made thereto without departing from the spirit and scope of the present invention.

For example, the shapes used to present the artwork displays may have as few as two possible positions or an infinite number depending on the artistic implementation desired. Another method of rotating and locking the marquee 30 can be a number of holes around the outer edge of the bezel 33 that can be placed onto a pin or threaded rod affixed to the base plate. Caps can be used to conceal the holes not in use.

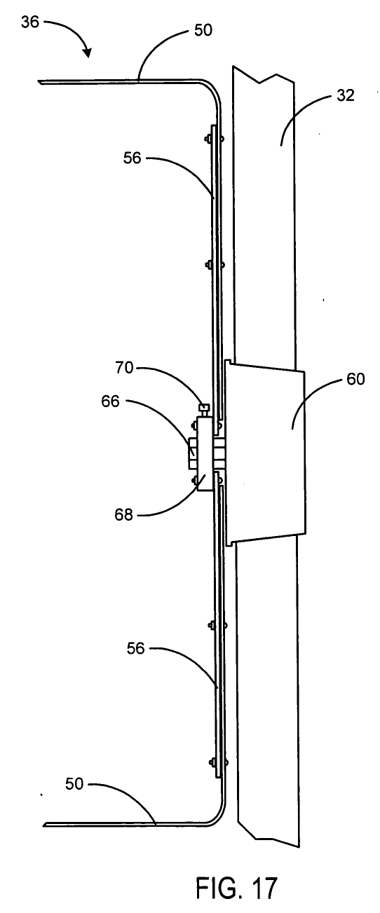

In a different embodiment shown in FIG. 17, a hollow (to allow for wiring) round or octagonal stud 66 extends forward from post mounting bracket 60. A circular bearing 68, affixed to light mounting plate 56 is positioned around the round or octagonal stud 66. The light mounting plate is affixed to marquee box 50. The marquee can now be rotated around a pivot point that is the round or octagonal stud 66. A setscrew or locking pin 70 is used to lock the marquee 36 in an orientation that allows for the intended presentation of the artwork display.

Another variation on the preferred embodiment could be the use of motors to move the marquee to a new position without the use of tools. The motor could respond to commands from the gaming machine's processor or a qualified service technician. The lighting on the marquee's bezel 33 (see FIG. 3) could support multiple colors and also be automatically changed using the same technique. For example, when a significant event occurs during game play, such as a jackpot or large winning outcome, the marquee could move in a rocking fashion, rotate completely around, or spin on a pivot, depending on its design. The lights could flash, rotate or change colors or a combination of such effects.

Each of these embodiments and obvious variations thereof is contemplated as falling within the spirit and scope of the claimed invention, which is set forth in the following claims.

What is claimed is:

1. A signage display for a gaming machine, the signage display comprising a support member adapted to be mounted in a plurality of different orientations and supporting artwork in each of the orientations.

2. The signage display of claim 1, further including a first light source positioned to illuminate the artwork and selected from a group consisting of incandescent, fluorescent, LEDs, neon, and cold cathode fluorescent lamp.

3. The signage display of claim 2, further including a second light source positioned around a periphery of the artwork.

4. The signage display of claim 1, wherein the support member is non-circular.

5. The signage display of claim 1, wherein the artwork is oriented for logical viewing.

6. The signage display of claim 1, wherein the support member supports different artwork in each of the orientations.

7. The signage display of claim 1, further including a mounting arrangement for mounting the support member.

8. The signage display of claim 7, wherein the mounting arrangement includes a pivot mechanism.

9. The signage display of claim 8, wherein the pivot mechanism includes a locking device.

10. The signage display of claim 8, wherein the pivot mechanism includes a positioning element.

11. A signage display for a gaming machine, comprising:
a support member; and
a mounting arrangement for positioning the support member in a plurality of different orientations, the support member supporting artwork in each of the orientations.

12. The signage display of claim 11, wherein the mounting arrangement includes a pivot mechanism.

13. The signage display of claim 11, wherein the support member supports different artwork in each of the orientations.

14. A method of altering a signage display for a gaming machine, the method comprising:
providing a support member having a first artwork element thereon, the support member being in a first of a plurality of different orientations;
removing the first artwork element from the support member;
positioning the support member in a second of the plurality of different orientations; and
installing a second artwork element on the support member.

15. The method of claim 14, wherein the support member is positioned to present the first artwork element in the first of the plurality of different orientations, and positioned to present the second artwork element in the second of the plurality of different orientations.

16. The method of claim 14, wherein the first and second artwork elements each include a panel adapted to be illuminated from within the support member.

17. The method of claim 14, wherein the support member is initially locked in the first of the plurality of different orientations, and further including the steps of unlocking the support member from the first of the plurality of different orientations and locking the supporting member in the second of the plurality of different orientations.

18. A kit for converting a gaming machine from a first game to a second game, the gaming machine including a signage display having a standardized support member, the support member supporting a first artwork element associated with the first game, the kit comprising a second artwork element associated with the second game and having substantially the same shape as the first artwork element, the second artwork element adapted to mount to the support member in place of the first artwork element with the support member reoriented to present the second artwork element for logical viewing.

19. The kit of claim 18, wherein the first and second artwork elements each include a panel adapted to be illuminated from within the support member.

20. A method of altering a signage display for a gaming machine, the method comprising:
providing a support member, the support member being in a first of a plurality of different orientations; and
positioning the support member in a second of the plurality of different orientations.

21. The method of claim 20, wherein the support member supports an artwork element.
